(19) United States
(12) Patent Application Publication
(10) Pub. No.: US 2022/0306205 A1
(43) Pub. Date: Sep. 29, 2022

(54) SUBFRAME

(71) Applicant: HONDA MOTOR CO., LTD., Tokyo (JP)

(72) Inventors: Yuho Ito, Wako-shi (JP); Ryosuke Kuno, Wako-shi (JP); Isao Obata, Wako-shi (JP)

(21) Appl. No.: 17/680,402

(22) Filed: Feb. 25, 2022

(30) Foreign Application Priority Data
Mar. 29, 2021 (JP) 2021-054966

(51) Int. Cl. B62D 21/11; B62D 3/12

(52) U.S. Cl. CPC B62D 21/11; B62D 3/126

(57) ABSTRACT

A subframe includes: a main body part; a vehicle body support part that supports the main body part to a vehicle body; and a stabilizer that is disposed above the main body part. The main body part includes a torque rod support part that supports a torque rod which is connected to a power unit. The torque rod support part includes: a front opening portion which is formed at a forward position and into which the torque rod is capable of being inserted; and a rear opening portion which is formed at a rearward position. The stabilizer is arranged at a rearward position that is overlapped with the rear opening portion in a forward/rearward direction.

### CROSS-REFERENCE TO RELATED APPLICATION

Priority is claimed on Japanese Patent Application No. 2021-054966, filed on Mar. 29, 2021, the contents of which are incorporated herein by reference.

### BACKGROUND

### Field of the Invention

The present invention relates to a subframe.

### Background

In the related art, a suspension member that is fixed to a lower part of a vehicle body is known (for example, refer to Japanese Unexamined Patent Application, First Publication No. 2005-59813).

### SUMMARY

However, in the suspension member described in Japanese Unexamined Patent Application, First Publication No. 2005-59813, a separate bracket that supports a torque rod which is connected to an engine or the like is required, and the degree of freedom of a layout of a vehicle component disposed in a space behind a bracket is limited.

An object of an aspect of the present invention is to provide a subframe capable of enhancing the degree of freedom of a layout of a vehicle component.

A subframe according to a first aspect of the present invention includes: a main body; a vehicle body support part that supports the main body to a vehicle body; and a stabilizer that is disposed above the main body, wherein the main body includes a torque rod support part that supports a torque rod which is connected to a power unit, the torque rod support part includes: a front opening portion which is formed at a forward position and into which the torque rod is capable of being inserted; and a rear opening portion which is formed at a rearward position, and the stabilizer is arranged at a rearward position that is overlapped with the rear opening portion in a forward/rearward direction.

According to this configuration, the torque rod support part includes the front opening portion which is formed at a forward position and into which the torque rod is capable of being inserted and the rear opening portion which is formed at a rearward position. Therefore, it is possible to arrange the stabilizer near the rear of the torque rod without arranging the stabilizer to avoid the rear of the torque rod where it is difficult to ensure a clearance. Further, the stabilizer is arranged at a rearward position that is overlapped with the rear opening portion in the forward/rearward direction. Thereby, it is possible to simplify the structure of the main body and enhance the degree of freedom of the layout of a steering gearbox that is affected by the layout of the stabilizer. Accordingly, it is possible to enhance the degree of freedom of the layout of a vehicle component that is disposed in a space behind the torque rod support part.

In a second aspect, a steering rack may be disposed behind the stabilizer in a state of being overlapped with the rear opening portion in the forward/rearward direction.

According to this configuration, the steering rack is disposed behind the stabilizer in a state of being overlapped with the rear opening portion in the forward/rearward direction. Thereby, it is possible to ensure a space in which a high stiffness part is provided below the torque rod support part of the subframe compared to a case where the stabilizer and the steering rack are arranged to be spaced from each other in a vertical direction. Accordingly, it is possible to enhance the degree of freedom of the layout of a vehicle component that is disposed in a space behind the torque rod support part while ensuring the stiffness of the torque rod support part.

A third aspect may include: a rear wall that is provided below the rear opening portion and extends along a surface perpendicular to the forward/rearward direction; and a high stiffness part that is rigidly connected to a rear part of the rear wall, wherein the stabilizer may be arranged above the high stiffness part.

According to this configuration, the rear wall that extends along the surface perpendicular to the forward/rearward direction is provided below the rear opening portion. Thereby, it is possible to design such that a cross-sectional coefficient of a cross-section perpendicular to a vehicle width direction is large, it is possible to enhance the stiffness of the torque rod support part, and it is possible to compensate the deficiency of the stiffness of the torque rod support part by forming the rear opening portion. In addition, the high stiffness part that is rigidly connected to the rear part of the rear wall is further provided. Thereby, it is possible to further enhance the stiffness of the torque rod support part while ensuring a space above the high stiffness part.

In a fourth aspect, the high stiffness part may include: a connection wall that extends rearward from an upper end of the rear wall; and a longitudinal wall that extends downward from a rear end of the connection wall.

According to this configuration, the high stiffness part includes the connection wall that extends rearward from the upper end of the rear wall. Thereby, it is possible to design such that a cross-sectional coefficient perpendicular to a vehicle width direction is large in a space behind and below the torque rod support part that does not affect the layout of a vehicle component. Accordingly, it is possible to effectively utilize the space behind and below the torque rod support part and further enhance the stiffness while ensuring a high degree of freedom of the layout of a vehicle component that is disposed in a space behind the torque rod support part. Further, the high stiffness part includes the longitudinal wall that extends downward from the rear end of the connection wall. Thereby, since the high stiffness part includes the connection wall that extends rearward from the upper end of the rear wall, it is possible to enhance the stiffness against a moment around the vertical direction. Further, since the high stiffness part is constituted of two members which are the connection wall and the longitudinal wall in which weak axes of the cross-section cross orthogonally to each other, it is possible to enhance the stiffness in all directions.

According to an aspect of the present invention, it is possible to provide a subframe capable of enhancing the degree of freedom of the layout of the vehicle component.

### BRIEF DESCRIPTION OF THE DRAWINGS

FIG. 1 is a perspective view of a subframe when seen from an upward forward direction according to an embodiment of the present invention.

FIG. 2 is a perspective view of the subframe when seen from an upward rearward direction according to the embodiment.

FIG. 3 is a cross-sectional view when seen in an arrow A direction in FIG. 2.

### DESCRIPTION OF EMBODIMENTS

Hereinafter, a subframe 100 according to an embodiment of the present invention will be described with reference to the drawings. In the drawings, an arrow FR represents a forward direction of a vehicle, an arrow RB represents a rearward direction of the vehicle, an arrow UP represents an upward direction of the vehicle, an arrow DW represents a downward direction of the vehicle, an arrow L represents a leftward direction of the vehicle, and an arrow R represents a rightward direction of the vehicle. A rightward/leftward direction of the vehicle may be referred to as a vehicle width direction. The subframe 100 has a substantially symmetrical structure in the rightward/leftward direction.

Accordingly, hereinafter, right and left configuration members may be described with the same reference numerals.

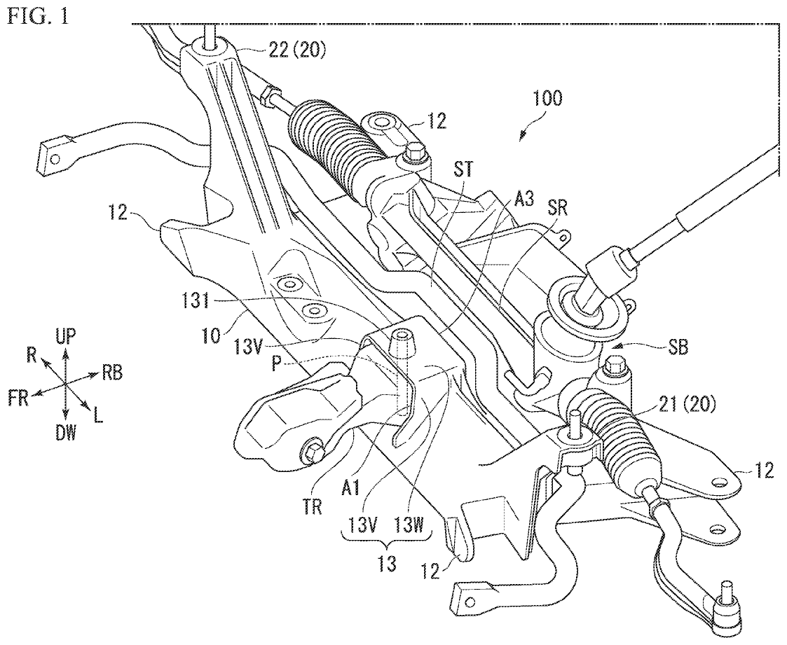

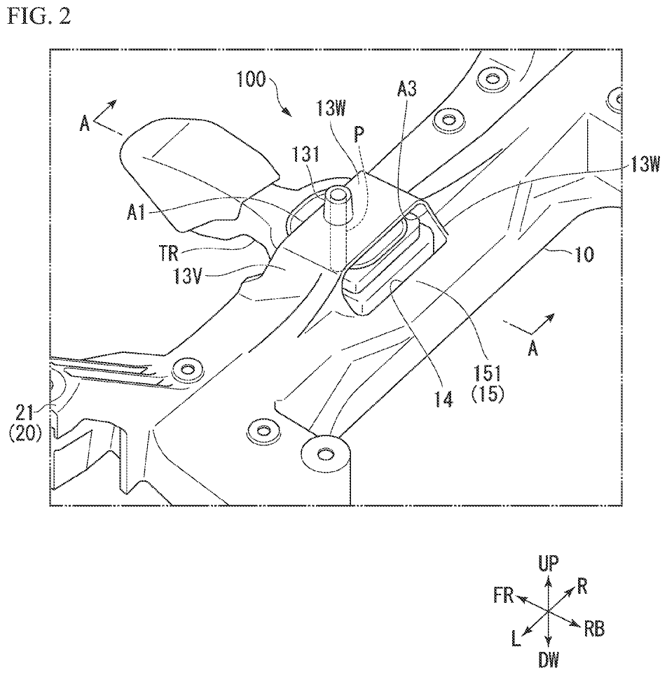

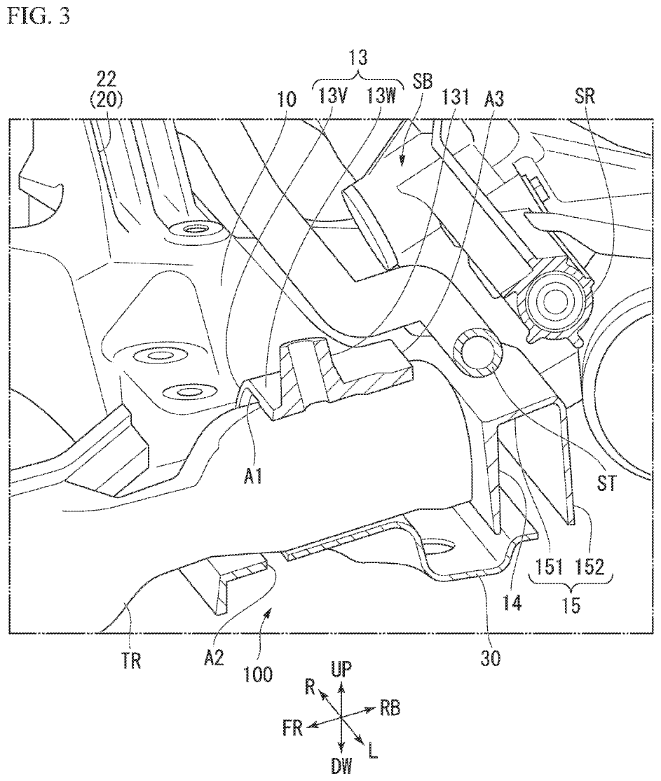

FIG. 1 is a perspective view of the subframe 100 when seen from an upward forward direction according to the embodiment of the present invention. FIG. 2 is a perspective view of the subframe 100 when seen from an upward rearward direction according to the embodiment. FIG. 3 is a cross-sectional view when seen in an arrow A direction in FIG. 2. A stabilizer ST and a steering gearbox SB are not shown in FIG. 2.

### (Subframe)

As shown in FIG. 1 to FIG. 3, the subframe 100 is a member that constitutes part of a skeleton of a vehicle together with a vehicle body (not shown). The subframe 100 is provided at a lower part of the vehicle body.

The subframe 100 includes a main body part 10 and a vehicle body support part 20 that supports the main body part 10 to the vehicle body. The main body part 10 and the vehicle body support part 20 are, for example, integrally formed by a die-cast molding method. The main body part 10 and the vehicle body support part 20 are, for example, made of an alloy of a non-iron metal such as aluminum.

In the subframe 100, at least a stabilizer ST that has a rod shape, extends along the vehicle width direction, and connects right and left suspensions (not shown) together is disposed above the main body part 10.

### (Vehicle Body Support Part)

The vehicle body support part 20 is a part that supports the main body part 10 to the vehicle body. The vehicle body support part 20 includes: a left vehicle body support part 21 that is disposed on a left side of the main body part 10 and is supported by a left side of the vehicle body; and a right vehicle body support part 22 that is disposed on a right side of the main body part 10 and is supported by a right side of the vehicle body. The left vehicle body support part 21 and the right vehicle body support part 22 are disposed symmetrically in the rightward/leftward direction to be away from each other in the vehicle width direction. The left vehicle body support part 21 and the right vehicle body support part 22 extend upward. The subframe 100 (the main body part 10) bridges the vehicle body in the vehicle width direction between the left vehicle body support part 21 and the right vehicle body support part 22 in a state where a space is formed between the vehicle body and the main body part 10. The subframe 100 may include not only the left vehicle body support part 21 and the right vehicle body support part 22 but another vehicle body support part 20.

### (Main Body Part)

The main body part 10 includes a suspension arm support part 12 and a torque rod support part 13. In the main body part 10, a stabilizer ST is arranged in a space between the main body part 10 and the vehicle body.

The suspension arm support part 12 supports a suspension arm (not shown) by a hinge.

### <Torque Rod Support Part>

The torque rod support part 13 supports a torque rod TR that is connected to a power unit (not shown). One end of the torque rod TR is connected to the subframe 100 by a hinge via a bush (not shown). Another end of the torque rod TR is connected to a power unit such as an engine. The torque rod support part 13 is arranged at the middle of the main body part 10 in the vehicle width direction.

In detail, the torque rod support part 13 protrudes above the main body part 10. The torque rod support part 13 forms a space in which one end of the torque rod TR can be accommodated. The torque rod support part 13 includes: a top plate 13W that supports one end of a shaft P which supports the torque rod TR; and a side plate 13V. The shaft P constitutes a hinge that swingably supports the torque rod TR.

The top plate 13W is a plate body having a substantially horizontal surface along an upper surface of the main body part 10. The top plate 13W is located at a further upward position than the upper surface of the main body part 10. The top plate 13W has a space in which the torque rod TR can be accommodated below the top plate 13W. The top plate 13W is formed integrally with the main body part 10 via the side plate 13V that extends upward from the main body part 10. The top plate 13W includes a first shaft support part 131 substantially at the middle in plan view. A reinforcement plate 30 is provided below the top plate 13W to be away from the accommodation space of the torque rod TR and a lower opening part A2 (refer to FIG. 3). The first shaft support part 131 that is provided on the top plate 13W supports one end of the shaft P. A second shaft support part (not shown) that is provided on the reinforcement plate 30 supports the other end of the shaft P.

The torque rod support part 13 includes: a front opening portion A1 which is formed at a forward position and into which the torque rod TR is capable of being inserted; and a rear opening portion A3 which is formed at a rearward position. The stabilizer ST is arranged at a rearward position that is overlapped with the rear opening portion A3 in a forward/rearward direction. In this way, the torque rod support part 13 includes the rear opening portion A3. Therefore, it is possible to arrange the stabilizer ST near the rear of the torque rod TR while ensuring a clearance without arranging the stabilizer ST to avoid the rear of the torque rod TR where it is difficult to ensure a clearance. Further, the stabilizer ST is arranged at a rearward position that is overlapped with the rear opening portion A3 in the forward/rearward direction. Thereby, it is possible to simplify the structure of the main body part 10 and enhance the degree of freedom of the layout of the steering gearbox SB that is affected by the layout of the stabilizer ST. Accordingly, it is possible to enhance the degree of freedom of the layout of a vehicle component that is disposed in a space behind the torque rod support part 13.

In the subframe 100, the steering rack SR is disposed behind the stabilizer ST in a state of being overlapped with the rear opening portion A3 in the forward/rearward direction as shown in FIG. 3. In this way, the stabilizer ST and the steering rack SR are arranged side by side in this order on the subframe 100 at the rear that is overlapped in the forward/rearward direction with the rear opening portion A3 of the torque rod support part 13. Thereby, it is possible to ensure a space in which a high stiffness part 15 is provided below the torque rod support part 13 of the subframe 100 compared to a case where the stabilizer ST and the steering rack SR are arranged to be spaced from each other in a vertical direction. Accordingly, it is possible to enhance the degree of freedom of the layout of a vehicle component that is disposed in a space behind the torque rod support part 13 while ensuring the stiffness of the torque rod support part 13.

The subframe 100 includes: the rear wall 14 that is provided below the rear opening portion A3 and extends along the surface perpendicular to the forward/rearward direction; and the high stiffness part 15 that is rigidly connected to the rear part of the rear wall 14. In the subframe 100, the stabilizer ST is arranged above the high stiffness part 15. In this way, the rear wall 14 that extends along the surface perpendicular to the forward/rearward direction is provided below the rear opening portion A3 of the subframe 100. Thereby, it is possible to design such that the cross-sectional coefficient of the cross-section perpendicular to the vehicle width direction is large, it is possible to enhance the stiffness of the torque rod support part 13, and it is possible to compensate the deficiency of the stiffness of the torque rod support part 13 by forming the rear opening portion A3. In addition, the high stiffness part 15 that is rigidly connected to the rear part of the rear wall 14 is further provided. Thereby, it is possible to further enhance the stiffness of the torque rod support part 13 while ensuring a space above the high stiffness part 15.

In detail, the high stiffness part 15 includes: a connection wall 151 that extends rearward from an upper end of the rear wall 14; and a longitudinal wall 152 that extends downward from a rear end of the connection wall 151. Thereby, it is possible to design such that the cross-sectional coefficient perpendicular to the vehicle width direction is large in a space behind and below the torque rod support part 13 that does not affect the layout of a vehicle component. Accordingly, it is possible to effectively utilize the space behind and below the torque rod support part 13 and further enhance the stiffness while ensuring a high degree of freedom of the layout of a vehicle component that is disposed in a space behind the torque rod support part 13. Further, since the high stiffness part 15 includes the connection wall 151 that extends rearward from the upper end of the rear wall 14, it is possible to enhance the stiffness against a moment around the vertical direction. Further, since the high stiffness part 15 is constituted of two members which are the connection wall 151 and the longitudinal wall 152 in which weak axes of the cross-section cross orthogonally to each other, it is possible to enhance the stiffness in all directions.

The high stiffness part 15 extends to the vehicle body support part 20. The high stiffness part 15 can preferably extend continuously from the left vehicle body support part 21 to the right vehicle body support part 22. In this way, since the high stiffness part 15 extends to the vehicle body support part 20, it is possible to enhance the stiffness of the torque rod support 13 and also enhance the entire stiffness of the subframe 100 that is supported by the vehicle body support part 20.

The technical scope of the present invention is not limited to the embodiment described above, and various modifications can be made without departing from the scope of the invention.

A component in the embodiment described above can be replaced by a known component without departing from the scope of the present invention, and the modification example described above may be appropriately combined.

What is claimed is:

1. A subframe comprising:
a main body part;
a vehicle body support part that supports the main body part to a vehicle body; and
a stabilizer that is disposed above the main body part,
wherein the main body part comprises a torque rod support part that supports a torque rod which is connected to a power unit,
the torque rod support part includes: a front opening portion which is formed at a forward position and into which the torque rod is capable of being inserted; and a rear opening portion which is formed at a rearward position, and
the stabilizer is arranged at a rearward position that is overlapped with the rear opening portion in a forward/rearward direction.

2. The subframe according to claim 1,
wherein a steering rack is disposed behind the stabilizer in a state of being overlapped with the rear opening portion in the forward/rearward direction.

3. The subframe according to claim 1, comprising:
a rear wall that is provided below the rear opening portion and extends along a surface perpendicular to the forward/rearward direction; and a high stiffness part that is rigidly connected to a rear part of the rear wall,
wherein the stabilizer is arranged above the high stiffness part.

4. The subframe according to claim 2, comprising:
a rear wall that is provided below the rear opening portion and extends along a surface perpendicular to the forward/rearward direction; and a high stiffness part that is rigidly connected to a rear part of the rear wall,
wherein the stabilizer is arranged above the high stiffness part.

5. The subframe according to claim 3,
wherein the high stiffness part comprises: a connection wall that extends rearward from an upper end of the rear wall; and a longitudinal wall that extends downward from a rear end of the connection wall.

6. The subframe according to claim 4,
wherein the high stiffness part comprises: a connection wall that extends rearward from an upper end of the rear wall; and a longitudinal wall that extends downward from a rear end of the connection wall.

7. The subframe according to claim 3,
wherein the high stiffness part extends to the vehicle body support part.

8. The subframe according to claim 4,
wherein the high stiffness part extends to the vehicle body support part.

9. The subframe according to claim 5,
wherein the high stiffness part extends to the vehicle body support part.

10. The subframe according to claim 6,
wherein the high stiffness part extends to the vehicle body support part.
